(19) United States
(12) Patent Application Publication
(10) Pub. No.: US 2003/0226868 A1
(43) Pub. Date: Dec. 11, 2003

(54) Disposable packaging and cutting assembly

(76) Inventor: Thomas Monden, Stetten (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/456,339

(22) Filed: Jun. 5, 2003

(30) Foreign Application Priority Data
Jun. 7, 2002 (DE) 102 25 436.2

(51) Int. Cl. B26F 3/02; B65H 35/10

(52) U.S. Cl. 225/39; 225/55

(57) ABSTRACT

A disposable packaging member (1) for a web or tape material (2) has an exit opening (4) for the tape material (2) that can be drawn out of the disposable packaging member (1) and a receiving part (7) for removably mounting a cutting assembly. The cutting assembly (11) includes at least one movable cutting unit, (15), a stationary support edge (14) for a material to be cut and a mounting means (13) for removably mounting the cutting assembly (11) on the packaging member. The disposable packaging member (1) can be combined with the cutting assembly (11).

### BACKGROUND OF THE INVENTION

The invention relates to a disposable packaging for a web or tape material with a dispensing opening for the web or tape material drawn from the disposable packaging. The invention relates further to a cutting assembly with at least one movable cutting unit and a stationary support edge for a material to be cut. Furthermore, the invention relates to the disposable packaging with the cutting assembly.

Web or tape material is generally supplied in rolled up form and often in disposable packaging for continued use. The web or tape material is rolled off in the desired length and cut at that length using a suitable means.

For plastic tape material coated with adhesive, so-called dispensers are known. The dispenser has a serrated cutting edge, for example, on which the rolled off plastic tape is separated from the still rolled up plastic tape. This type of dispenser is suitable especially for thin materials, such as thin metal or plastic foils.

Thicker foils or webs that are supplied in rolled form for further use rolled off and then cut to the desired length using a separate tool (for example, with scissors or with a shears type metal cutter). The same process applies to foils and webs or tapes, which as a result of their material properties, for example, cannot be cut to the desired length using a tearing or cutting edge.

U.S. Pat. No. 5,771,769 discloses a dispenser for a tape material that is cut to length using a blade arranged on the dispenser and movable along the outside of the dispenser. The blade is a fixed component of the dispenser. WO 99/54245 discloses a dispenser for a tape material that has a flap-like cover provided with a serrated cutting edge. A tape material drawn from this dispenser is cut by flipping the cover down [to its closed position].

The drawback of the known solution is that the disposable packaging of the tape material is removed from the tape material prior to the use of the tape material and the tape material must be used in its separate dispensing and cutting assembly, in order for the tape material to be cut to the desired length. In the case of thicker tape materials or tape materials with specific material characteristics, a separate tool for cutting the tape material to length is required, which is not always at hand. Cutting assemblies for such tape materials are expensive to manufacture and represent a multiple of the costs relative to the packaging.

### SUMMARY OF THE INVENTION

The primary object of the present invention is to provide a simple disposable packaging for a web or tape material, which can be used in the packaging of the web or tape material. A further object of the present invention is to provide a cutting assembly that can be used for different types of web or tape material.

According to the invention, a disposable packaging member for tape material has an exit opening for the tape material drawn from the disposable packaging, whereby the disposable packaging member has an assembly for removably securing a cutting assembly.

With the exit opening and the assembly for replaceable fastening of a cutting assembly, the disposable packaging according to the invention can be used up to the time that the tape material packaged in the disposable packaging is exhausted. The disposable packaging is essentially suitable for any type of tape material such as, for example, tape material made of metal, plastic, textile, composite material and the like.

The tape material can be drawn through the exit or dispensing opening of the disposable packaging member out of the disposable packaging to the desired length. A suitable cutting assembly can be provided, depending on the material characteristics of the tape material, on the device for replaceable mounting of a cutting assembly. For example, for a disposable packaging member with a tape material having a certain material thickness, the device is configured for receiving a shears type metal cutter. If the tape material in the disposable packaging member is exhausted, the disposable packaging is preferably properly disposed of and the shears type metal cutter is mounted on the new disposable packaging, which for its part has a device for removably mounting of a cutting assembly for cutting a tape material to length.

Preferably the device for removably mounting of a cutting assembly includes a slot-shaped receiving part which is optionally arranged in proximity to an edge of the packaging member. A suitable cutting assembly, for example, can be inserted into the slot-shaped receiving part for cutting to length a tape material. The receiving part is disposed preferably in proximity to one of the edges of the packaging member. A plurality, preferably disposed alongside each other, of recesses can be provided on the disposable packaging member. The receiving part is preferably configured for receiving different cutting assemblies so that on one and the same receiving part differently equipped cutting assemblies can be mounted.

Preferably, the receiving part is a wall section of the disposable packaging member for removably mounting the cutting assembly. In this configuration of the disposable packaging the cutting assembly can be mounted on the wall section and include it.

Advantageously, the receiving part is arranged parallel to the exit opening. The tape materials is drawn out of the disposable packaging member through the exit opening and led to the receiving part for removably mounting the cutting assembly. In virtue of the parallel arrangement of the exit opening to the receiving part, the tape material led to the receiving part makes its way perpendicularly in the direction of the exit of the tape material with a cutting assembly mounted on the receiving part.

In a preferred arrangement, the disposable packaging member has a measuring device for measuring the length of the tape material drawn from the disposable packaging. Prior to cutting to length of the tape material, the length of the tape material withdrawn can be measured on the disposable packaging member. The use of a separate measuring means is thus eliminated. Preferably the measuring device extends perpendicularly from the exit opening. If the receiving part is arranged parallel to the exit opening, the measurement device is provided, for example, between the exit opening and the receiving part on the disposable packaging member in the form of an imprint or a stamp on the corresponding surface of the disposable packaging member. The measurement device can, in this case, have along one side of the surface a measurement increment in centimeters and along the opposite side a second measurement increment in inches.

According to the invention a cutting assembly has at least one displaceable cutting unit and a stationary support edge for a material to be cut, whereby the cutting assembly has a mounting means for removably mounting the cutting assembly on the packaging member. The mounting means is preferably configured so that the cutting assembly can be securely mounted for the cutting operation of the material to be cut. If the available material in the packaging is exhausted, the cutting assembly can be removed from the packaging member and is available for further use on another packaging member.

Preferably, the mounting means has at least two support elements that include at least one part of the packaging member, optionally clamping it. For securing the cutting assembly on the packaging member during the cutting operation it is advantageous if the mounting means partially encloses the packaging member. For example, the mounting means has spike-like points so that the cutting assembly can be stuck onto the packaging member. In one embodiment of the mounting means with spike-like points, for example, an additional frame part is provided on the mounting means, which includes a corner section of the packaging member. Undesirable movement of the cutting assembly during the cutting operation is generally prevented. In a preferred embodiment of the mounting means the at least two support elements are configured so that they clampingly include at least a part of the packaging member. For this purpose, the support elements can be configured as flat parts disposed opposite to each other, which grip a wall section of the packaging like a clip. At least one of these support elements can have the form of a cutting edge so that the cutting assembly, when placed on the packaging member in the area of a wall section in proximity to an edge, cuts a corresponding opening so that the cutting assembly is securely fastened to the packaging member and can be replaced. The packaging member itself can be provided with a recess which enables removable mounting of the cutting assembly with the clamping mounting means on the packaging member.

Preferably, at least the one movable cutting unit is hinge connected to the stationary support edge using a hinge bearing. The hinge bearing is, for example, configured as a pivot bearing with a pivot bolt or as a film hinge. The at least one cutting unit is rotatable about the pivot bearing so that the material to be cut situated between the at least one cutting element and the stationary support edge can be severed. To enable different tape materials to be cut to length using one and the same cutting assembly, the at least one cutting unit has interchangeable cutting blades. A further possibility is represented by the arrangement of a plurality of cutting units equipped with different cutting blades on the cutting assembly, whereby each of these cutting units can be pivoted on its own towards the support edge.

The hereinbefore described mounting means is preferably arranged on the stationary support edge. The stationary support edge can in its turn have a cutting edge or serrated projection for cutting to length the tape material. A tape material with a minimal material thickness can be torn off or cut to length over this edge without the use of the at least one movable cutting unit. In contrast, in the combination of the at least one movable cutting unit and the stationary support edge equipped with a cutting blade provides a shears type function for the cutting assembly.

Pursuant to the invention a cutting assembly according to the invention is provided on a disposable packaging member. The cutting assembly is removed from the disposable packaging after consumption of the tape material present in the disposable packaging and arranged on the next disposable packaging. With the configuration of the disposable packaging and the configuration of the cutting assembly, the result is a preferred combination of the individual elements according to the invention.

In the following detailed description and the entirety of the patent claims other advantageous embodiments and combinations of features are possible.

### BRIEF DESCRIPTION OF THE DRAWINGS

The invention will be more completely described in the following by means of an exemplary embodiment, wherein:

FIG. 1 represents a perspective view of a, disposable packaging according to the invention having a cutting assembly according to the invention that is shown detached from a disposable packaging member, and

FIG. 2 represents a perspective view of the disposable packaging member according to the invention with cutting assembly according to the invention arranged on the disposable packaging member prior to cutting a tape material to length.

In principle, identical parts are referenced with the same reference numbers in the figures.

### DETAILED DESCRIPTION OF THE INVENTION

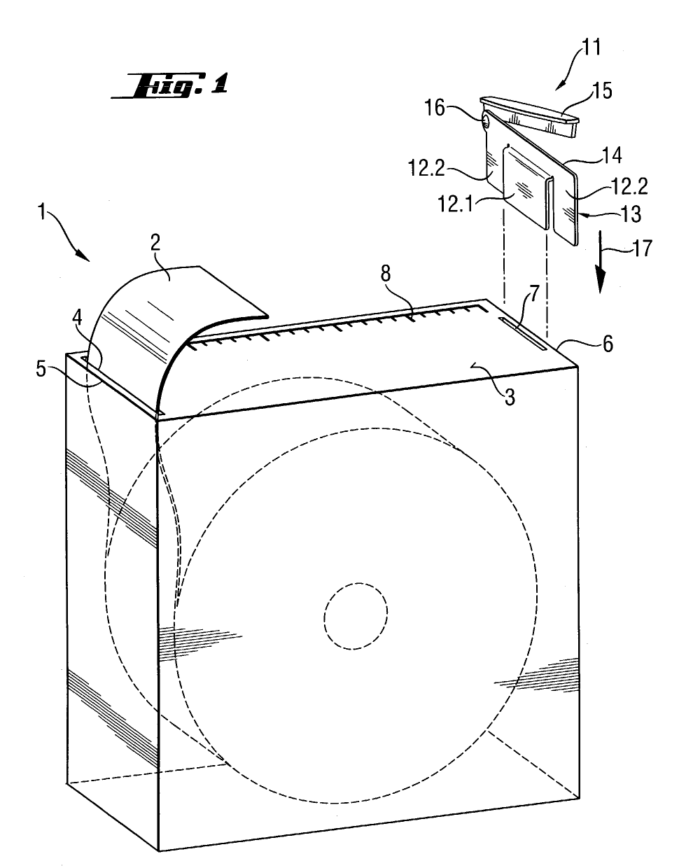

FIG. 1 shows a perspective representation of a disposable packaging member 1 according to the invention with a cutting assembly 11 according to the invention detached from the disposable packaging member. The disposable packaging member 1 for a rolled up metal tape 2 is in this embodiment a square shaped box, for example, which is fabricated from cardboard or plastic. The disposable packaging member 1 has at a first edge 5 transverse to an external surface 3 of the packaging member, an exit opening 4 for the metal tape 2 present in the disposable packaging member 1. At an opposite second edge 6 of the external surface-3 of the packaging member disposed opposite to the first edge, a slot-shaped receiving part 7 is provided parallel to the exit opening for removably mounting the cutting assembly 11. Between the exit opening 4 and the receiving part 7 a centimeter increment 8 is printed with intermediate intervals in millimeters along the one longitudinal edge of the external surface 3 of the disposable packaging member 1.

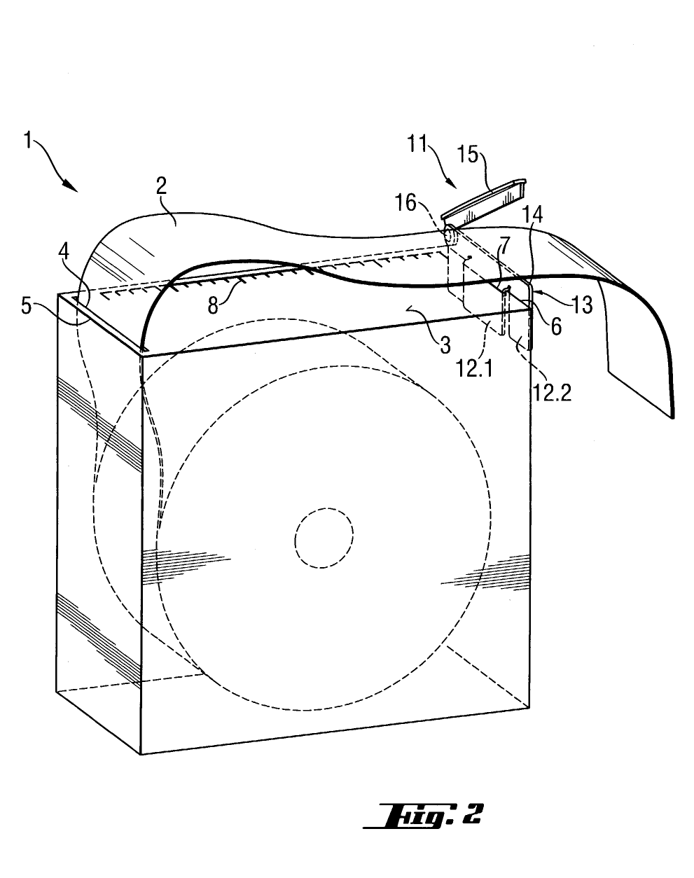

The cutting assembly II includes a mounting means 13 formed from two support elements 12.1, 12.2 and a movable cutting unit 15. The movable cutting unit 15 can be pivoted on a hinge 16 and is connected with a stationary support edge 14. The support elements 12.1, 12.2 are arranged on the cutting assembly 11 essentially parallel and at a distance from each other, note FIG. 2.

The cutting assembly 11 according to the invention can be mounted in the direction of the arrow 17 in FIG. 1 on the edge 6 of the wall surface 3 of the disposable packaging member 1 according to the invention, which is formed by the side wall of the disposable packaging member 1 and the receiving part 7. The support elements 12.1 and 12.2 engage the edge 6 and secure the cutting assembly 11 against unintentional displacement of the cutting assembly 11. The cutting assembly 11 can be removed from the disposable packaging member according to the invention by movement in the direction opposite to the arrow 17.

FIG. 2 represents a perspective view of the disposable packaging member 1 according to the invention with the cutting assembly arranged on the disposable packaging member according to the invention prior to cutting a tape material to length. The metal tape 2 to be cut to length is drawn out from the disposable packaging member 1 and led through the cutting assembly 11 until the desired length, if applicable the length measured on the centimeter scale 8, of the metal tape is in front of the cutting assembly 11. By pivoting the cutting unit 15 in the direction of the disposable packaging member 1 the metal tape 2 is cut to length.

In summary, it is reiterated that a simple disposable packaging for a web or tape material is provided, which can be used for packaging the web or tape material. In addition, a cutting assembly is provided that can be used for different types of tape material and can be combined with the disposable packaging.

What is claimed is:

1. A disposable packaging for a roll of a web or tape material comprising a disposable packaging member (1) for holding the roll of material (2), an exit opening (4) through which the tape material is withdrawn from said disposable packaging member and means for removably mounting a cutting assembly for cutting the tape material on said disposable packaging member.

2. A disposable packaging as set forth in claim 1, wherein means for removably mounting comprising a surface (3) of said disposable packaging member (1) containing a slot-shaped receiving part (7) spaced from said exit opening (4) and from which the tape material is withdrawn from the disposable packaging member (1).

3. A disposable packaging, as set forth in claim 1, wherein said receiving part (7) is located adjacent an edge (6) of said disposable packaging member spaced from said exit opening (4).

4. A disposable packaging, as set forth in claim 2, wherein said disposable packaging member (1) is a box-shaped member and said edge (6) is formed at an end of said surface (3) of said box-shaped member adjacent said slot-shaped receiving part (7).

5. A disposable packaging, as set forth in claim 3, wherein said receiving part (7) is arranged parallel to said exit opening (4).

6. A disposable packaging, as set forth in claim 5, wherein said box-shaped member (1) has a means on said surface (3) for measuring the length of the tape material (2) removed from said disposable packaging member (1).

7. A disposable packaging, as set forth in claim 6, wherein said measuring means (8) extends perpendicularly from said exit opening (4).

8. A cutting assembly for cutting tape material held in a packaging member (1), wherein the cutting assembly (11) includes at least one movable cutting unit (15) and a stationary support edge (14) for the tape material (2) to be cut, and a mounting means (13) for removably mounting said cutting assembly on said packaging member (1)

9. A cutting assembly, as set forth in claim 8, wherein said mounting means (13) comprises at least two cooperating support elements engageable with said packaging member (1).

10. A cutting assembly, as set forth in claim 8, wherein said at least one movable cutting unit (15) is pivotably connected by a pivot hinge (16) with said stationay support edge (14).

11. A disposable packaging, as set forth in claim 1, including a cutting assembly (11) as set forth in claim 8.
